(19) United States
(12) Patent Application Publication
(10) Pub. No.: US 2024/0232610 A9
(43) Pub. Date: Jul. 11, 2024

(54) DNN TRAINING ALGORITHM WITH DYNAMICALLY COMPUTED ZERO-REFERENCE

(71) Applicant: INTERNATIONAL BUSINESS MACHINES CORPORATION, ARMONK, NY (US)

(72) Inventor: Malte Johannes Rasch, Chappaqua, NY (US)

(21) Appl. No.: 18/048,436

(22) Filed: Oct. 20, 2022

(51) Int. Cl. G06N 3/08; G06N 3/047

(52) U.S. Cl. CPC G06N 3/08; G06N 3/047

(57) ABSTRACT

A computer implemented method includes performing a gradient update for a stochastic gradient descent (SGD) of a deep neural network (DNN) using a first set of hidden weights stored in a first matrix comprising a Resistive Processing Unit (RPU) crossbar array. A second matrix comprising a second set of hidden weights is stored in a digital medium. A third matrix comprising a set of reference values is computed upon a transfer cycle of the first set of weights from the first matrix to the second matrix, accounting for a sign-change (chopper). The third matrix is stored in the digital medium. A third set of weights is updated for the DNN from the second matrix when a threshold is reached for the second set of weights, in a fourth matrix comprising a RPU crossbar array.

### BACKGROUND

### Technical Field

The present disclosure generally relates to Deep Learning, and more particularly, to systems and methods of training a Deep Neural Network using hardware elements.

### Description of the Related Art

A deep neural network (DNN) can be embodied in an analog cross-point array of resistive devices such as resistive processing units (RPUs). RPU devices generally include a first terminal, a second terminal and an active region. A conductance state of the active region identifies a weight value of the RPU, which can be updated/adjusted by application of a signal to the first/second terminals.

DNN based models have been used for a variety of different cognitive based tasks such as object and speech recognition and natural language processing. DNN training is salient in providing a high level of accuracy when performing such tasks. Training large DNNs is a computationally intensive task. Most popular methods of DNN training, such as backpropagation and stochastic gradient decent (SGD), involve the RPUs to be “symmetric” to work accurately. Typical systems assume the symmetry point is correctly estimated and stored initially to a reference device array. The symmetry point may be estimated incorrectly and can also be written incorrectly including noise.

### SUMMARY

According to an embodiment of the present disclosure, a computer implemented method includes performing a gradient update for a stochastic gradient descent (SGD) of a deep neural network (DNN) using a first set of hidden weights stored in a first matrix comprising a Resistive Processing Unit (RPU) crossbar array. A second matrix comprising a second set of hidden weights is stored in a digital medium. A third matrix comprising a set of reference values is computed upon a transfer cycle of the first set of weights from the first matrix to the second matrix, accounting for a sign-change (chopper). The third matrix is stored in the digital medium. A third set of weights is updated for the DNN from the second matrix when a threshold is reached for the second set of weights, in a fourth matrix comprising a RPU crossbar array. The device has the technical effect of increasing efficiency and accuracy of system computations on data used in RPU systems.

In one embodiment, which may be combined with the preceding embodiment, the second set of weights accounts for a set of previous reference values from a prior iteration of the transfer cycle. This allows more efficient computing capabilities.

In one embodiment, which may be combined with the preceding embodiments, a fifth matrix, stored in the digital medium, is configured to compute a next set of reference values from values read from the first matrix, during a chopper cycle. The fifth matrix is configured to partially update the third matrix, after the chopper cycle is completed. This enables greater accuracy of data manipulation.

In one embodiment, which may be combined with the preceding embodiments, the computing for the SGD includes a fifth matrix comprising a set of previous reference values, and storing the fifth matrix in the digital medium. This allows more efficient computing capabilities.

In one embodiment, which may be combined with the preceding embodiments, the assigning the set of reference values to the set of previous reference values in the digital medium occurs at a chopper switching time. This allows more accurate computing capabilities.

In one embodiment, which may be combined with the preceding embodiments, the resetting the set of reference values to zero occurs at the chopper switching time. This allows more efficient computing capabilities.

In one embodiment, which may be combined with the preceding embodiments, the device is configured to switch a sign of the chopper at the chopper switching time. This enables greater accuracy of data manipulation.

In one embodiment, which may be combined with the preceding embodiments, no RPU crossbar array is used for storing the set of reference values. This enables more efficient use of space in the IC array.

In one embodiment, which may be combined with the preceding embodiments, a set of previous reference values are set to a recent read-out weight vector. This enables more efficient use of space in the IC array.

According to an embodiment of the present disclosure, a non-transitory computer readable storage medium tangibly embodying a computer readable program code having computer readable instructions to solve a machine learning task, that, when executed, the instructions cause a computer device to carry out a method. The method includes performing a gradient update for a stochastic gradient descent (SGD) of a deep neural network (DNN) using a first set of weights stored in a first matrix comprising a Resistive Processing Unit (RPU) crossbar array. A second matrix comprising a second set of weights is stored in a digital medium. A third matrix comprising a set of reference values is computed for the SGD, upon a transfer cycle of the first set of weights from the first matrix to the second matrix, accounting for a chopper. The third matrix is stored in the digital medium. A third set of weights is updated for the DNN from the second matrix when a threshold is reached for the second set of weights, in a fourth matrix comprising a RPU crossbar array. The device has the technical effect of increasing efficiency and accuracy of system computations on data used in RPU systems.

According to an embodiment of the present disclosure a device including a first matrix comprises a Resistive Processing Unit (RPU) crossbar array with a first set of weights configured for a gradient update for a stochastic gradient descent (SGD) of a deep neural network (DNN). The device includes a second matrix comprising a second set of weights stored in a digital medium. Further the device includes a third matrix comprising a set of reference values computed for the SGD, stored in the digital medium, wherein the set of reference values is computed upon a transfer cycle of the first set of weights from the first matrix to the second matrix, accounting for a chopper. The device may also include a fourth matrix comprising a RPU crossbar array storing a third set of weights for the DNN that are updated from the second matrix when a threshold is reached for the second set of weights. The device has the technical effect of increasing efficiency and accuracy of system computations on data used in RPU systems.

In one embodiment, which may be combined with the preceding embodiment, the second set of weights accounts for a set of previous reference values from a prior iteration of the transfer cycle. This allows more efficient computing capabilities.

In one embodiment, which may be combined with the preceding embodiments, the set of reference values accounts for a switching frequency. This enables greater accuracy of data manipulation.

In one embodiment, which may be combined with the preceding embodiments, a fifth matrix comprising a set of previous reference values computed for the SGD, is stored in the digital medium. This allows more efficient computing capabilities.

In one embodiment, which may be combined with the preceding embodiments, the device assigns the set of reference values to the set of previous reference values in the digital medium at a chopper switching time. This allows more efficient computing capabilities.

In one embodiment, which may be combined with the preceding embodiments, the device resets the set of reference values to zero at the chopper switching time. This allows more efficient computing capabilities.

In one embodiment, which may be combined with the preceding embodiments, the device switches a sign of the chopper at the chopper switching time. This enables greater accuracy of data manipulation.

In one embodiment, which may be combined with the preceding embodiments, no RPU crossbar array is used for storing the set of reference values. This enables more efficient use of space in the IC array.

In one embodiment, which may be combined with the preceding embodiments, a set of previous reference values is set to a recent read-out weight vector. This enables more efficient use of space in the IC array.

The techniques described herein may be implemented in a number of ways. Example implementations are provided below with reference to the following figures.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 is a schematic diagram illustrating a DNN having a weight matrix W, an A matrix, and a hidden matrix H;

FIG. 2 is a diagram illustrating a DNN embodied in an analog cross-point array of RPU devices according to an embodiment;

FIG. 3 is a process flow illustrating an example methodology for training a DNN according to an embodiment;

FIGS. 4A-4B are diagrams illustrating interconnected arrays with a digital memory used for estimating reference values on the fly;

FIG. 5 is a diagram illustrating a forward cycle y=Wx being performed according to an embodiment;

FIG. 6 is a diagram illustrating a backward cycle z=W^{T}δ being performed according to an embodiment;

FIG. 7 is a diagram illustrating the array A being updated with x propagated in the forward cycle and δ propagated in the backward cycle according to an embodiment;

FIG. 8 is a diagram illustrating a forward cycle y′=Aeᵢ being performed on the weight matrix according to an embodiment;

FIG. 9. is a diagram illustrating the hidden matrix H being updated with the values calculated in the forward cycle of the A matrix;

FIG. 10 is a schematic diagram of the hidden matrix H 902 being selectively applied back to the weight matrix W 1010 according to an embodiment;

FIG. 11 is a diagram illustrating an example one hot encoded vector according to an embodiment;

FIG. 12 is a diagram illustrating an example detailed algorithm according to an embodiment;

FIG. 13 is a diagram illustrating an example detailed sub-algorithm according to an embodiment;

FIG. 14 is a diagram illustrating an example apparatus that can be employed in carrying out one or more of the present techniques according to an embodiment.

### DETAILED DESCRIPTION

### Overview

In the following detailed description, numerous specific details are set forth by way of examples in order to provide a thorough understanding of the relevant teachings. However, it should be apparent that the present teachings may be practiced without such details. In other instances, well-known methods, procedures, components, and/or circuitry have been described at a relatively high-level, without detail, in order to avoid unnecessarily obscuring aspects of the present teachings.

Provided herein are DNN training techniques with asymmetric RPU devices. The DNN is trained by using two tunable resistive device arrays and two or three digital memory arrays. The methods may include using an RPU crossbar array to represent the weights of the DNN. An additional crossbar array per weight may be used to compute the gradient update, without the need for a third tunable RPU array used to store a reference. Further, updates of both RPU arrays may occur according to the algorithms described herein.

In typical systems, the symmetry point, of each device may be incorrectly estimated. The symmetry point is the conductance where the conductance change response to a single pulsed update in the positive direction is on average of the same as in the negative direction. The symmetry point may be wrongly written onto the reference device with noise so that a wrong value is subtracted during gradient value readout. The update device may be variable so that its symmetry point is unstable and moves with time. Additionally, oftentimes the input is too sparse or the number of devices is too large so that the symmetry point is only reached slowly and transient offsets remain. Additionally adding a dedicated reference device array is costly in integrated circuit chip area. Embodiments overcome these limitations by using a digital memory for storing a metrics used dynamically on the fly to estimate the reference.

Accordingly, one or more of the methodologies discussed herein may obviate a need for time consuming data processing by the user. This may have the technical effect of reducing computing resources used by one or more devices within the system. Examples of such computing resources include, without limitation, processor cycles, network traffic, memory usage, storage space, and power consumption.

It should be appreciated that aspects of the teachings herein are beyond the capability of a human mind. It should also be appreciated that the various embodiments of the subject disclosure described herein can include information that is impossible to obtain manually by an entity, such as a human user. For example, the voltage inputs, and conductance storage values discussed herein, are impossible for a human user to perform.

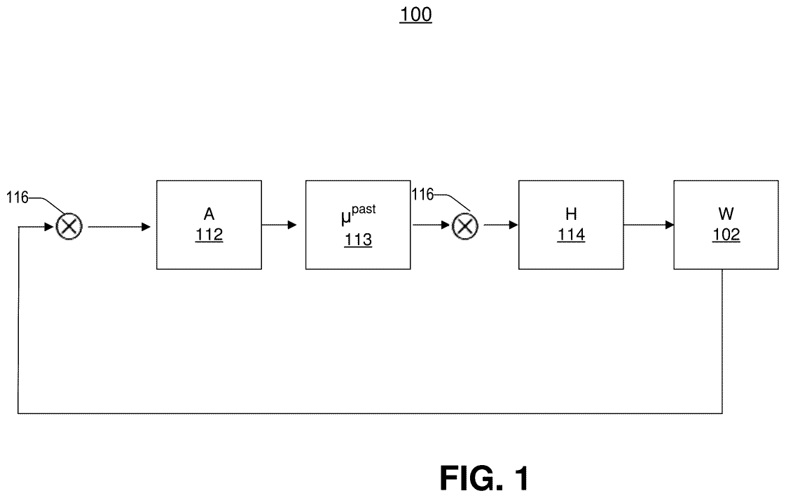

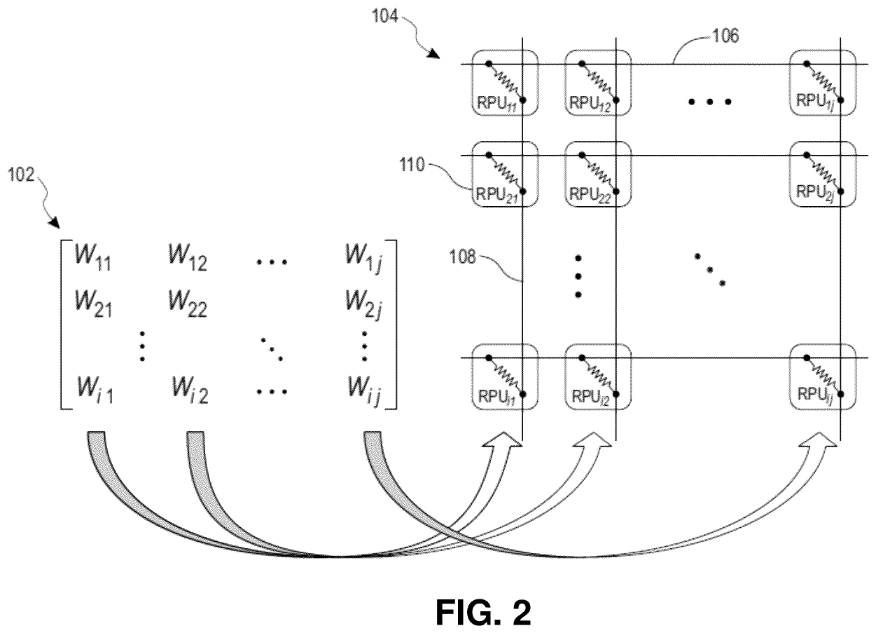

Turning now to the figures, FIG. 1 is a schematic diagram illustrating a DNN 100 having a weight matrix W 102, an A matrix 112, a μ^{past} matrix 113, and a hidden matrix H 114. The weight matrix W 102 is iteratively trained using the A matrix 112, the μ^{past} matrix 113, and the hidden matrix 114, as indicated by the arrow direction shown in FIG. 1. As highlighted above, the weight matrix W 102 can be embodied in an analog cross-point array of RPUs. See, for example, the schematic diagram shown in FIG. 2.

As shown in FIG. 2, each parameter (weight wᵢⱼ) of algorithmic (abstract) weight matrix 102 is mapped to a single RPU device (RPUᵢⱼ) on hardware, namely a physical cross-point array 104 of RPU devices. Cross-point array 104 includes a series of conductive row wires 106 and a series of conductive column wires 108 oriented orthogonal to, and intersecting, the conductive row wires 106. The intersections between the row and column wires 106 and 108 are separated by RPUs 110 forming cross-point array 104 of RPU devices. Each RPU 110 can include a first terminal, a second terminal, and an active region. A conduction state of the active region identifies a weight value of the RPU 110, which can be updated/adjusted by application of a signal to the first/second terminals. Further, three-terminal (or even more terminal) devices can serve effectively as two-terminal resistive memory devices by controlling the extra terminals.

Each RPU 110 (RPUᵢⱼ) is uniquely identified based on its location in (i.e., the i^{th} row and j^{th} column) of the cross-point array 104. For instance, working from the top to bottom, and from the left to right of the cross-point array 104, the RPU at the intersection of the first-row wire 106 and the first column wire 108 is designated as RPU₁₁, the RPU at the intersection of the first row wire 106 and the second column wire 108 is designated as RPU₁₂, and so on. Further, the mapping of the parameters of weight matrix 102 to the RPUs of the cross-point array 104 follows the same convention. For instance, weight uᵢ₁ of weight matrix 102 is mapped to RPUᵢ₁ of the cross-point array 104, weight wᵢ₂ of weight matrix 102 is mapped to RPUᵢ₂ of the cross-point array 104, and so on.

The RPUs 110 of the cross-point array 104, in effect, function as the weighted connections between neurons in the DNN. The conduction state (e.g., resistance) of the RPUs 110 can be altered by controlling the voltages applied between the individual wires of the row and column wires 106 and 108, respectively. Data is stored by alteration of the RPU's conduction state. The conduction state of the RPUs 110 is read by applying a voltage and measuring the current that passes through the target RPU 110. All of the operations involving weights are performed fully in parallel by the RPUs 110.

In machine learning and cognitive science, DNN based models are a family of statistical learning models inspired by the biological neural networks of animals, and in particular the brain. These models may be used to estimate or approximate systems and cognitive functions that depend on many inputs and weights of the connections which are generally unknown. DNNs are often embodied as so-called “neuromorphic” systems of interconnected processor elements that act as simulated “neurons” that exchange “messages” between each other in the form of electronic signals. The connections in DNNs that carry electronic messages between simulated neurons are provided with numeric weights that correspond to the strength or weakness of a given connection. These numeric weights can be adjusted and tuned based on experience, making DNNs adaptive to inputs and capable of learning. For example, a DNN for handwriting recognition is defined by a set of input neurons which may be activated by the pixels of an input image. After being weighted and transformed by a function determined by the network's designer, the activations of these input neurons are then passed to other downstream neurons. This process is repeated until an output neuron is activated. The activated output neuron determines which character was read.

The DNN 100 illustrated in FIG. 1 is trained by updating the weight values Wᵢⱼ through the A matrix 112 and then summing the resulting output from the A matrix 112 into the hidden matrix 114 until an element of the hidden matrix 114 (i.e., Hᵢⱼ) reaches a threshold value, as explained in detail below. Before and after the weight values are updated in the A matrix 112, however, a chopper 116 multiplies the inputs and outputs signals by a chopper value. The chopper value at a given time is equal to either a positive one (+1) or a negative one (−1). The chopper 116 randomly or regularly flips between the chopper values, such that for part of the training period the updates are applied to the A matrix 114 with an opposite sign. This sign flip by the chopper 116 means that any “bias” contributed to the weight value by the A matrix 112 has one sign (i.e., positive or negative) for some periods of the training time, and the other sign (i.e., negative or positive) for other periods of the training time. The chopping period or switching probability may also be assigned by a user. Bias can be inherent in any analog system, including non-ideal RPUs that may be used in the DNN 100.

For training purposes, such an ideal device perfectly implements the DNN training process of backpropagation and stochastic gradient decent (SGD). Backpropagation is a training process performed in three cycles: a forward cycle, a backward cycle, and a weight update cycle which are repeated multiple times until a convergence criterion is met. Stochastic gradient decent (SGD) uses the backpropagation to calculate the error gradient of each parameter (weight wᵢⱼ).

To perform backpropagation, DNN based models are composed of multiple processing layers that learn representations of data with multiple levels of abstraction. For a single processing layer where N input neurons are connected to M output neurons, the forward cycle involves computing a vector-matrix multiplication (y=Wx) where the vector x of length N represents the activities of the input neurons, and the matrix W of size M×N stores the weight values between each pair of the input and output neurons. The resulting vector y of length M is further processed by performing a non-linear activation on each of the resistive memory elements and then passed to the next layer.

Once the information reaches to the final output layer, the backward cycle involves calculating the error signal and backpropagating the error signal through the DNN. The backward cycle on a single layer also involves a vector-matrix multiplication on the transpose (interchanging each row and corresponding column) of the weight matrix (z=W^{T}δ), where the vector δ of length M represents the error calculated by the output neurons and the vector z of length N is further processed using the derivative of neuron non-linearity and then passed down to the previous layers.

Lastly, in the weight update cycle, the weight matrix W is updated by performing an outer product of the two vectors that are used in the forward and the backward cycles. This outer product of the two vectors is often expressed as W←W+η(δx^{T}), where η is a global learning rate.

All of the operations performed on the weight matrix W during this backpropagation process can be implemented with the cross-point array 104 of RPUs 110 having a corresponding number of M rows and N columns, where the stored conductance values in the cross-point array 104 form the matrix W. In the forward cycle, input vector x is transmitted as voltage pulses through each of the column wires 108, and the resulting vector y is read as the current output from the row wires 106. Similarly, when voltage pulses are supplied from the row wires 106 as input to the backward cycle, then a vector-matrix product is computed on the transpose of the weight matrix W^{T}. Finally, in the update cycle voltage pulses representing vectors x and δ are simultaneously supplied from the column wires 108 and the row wires 106. In this configuration, each RPU 110 performs a local multiplication and summation operation by processing the voltage pulses coming from the corresponding column wire 108 and row wire 106, thus achieving an incremental weight update.

A symmetric RPU may implement backpropagation and SGD perfectly. Namely, with such ideal RPUs wᵢⱼ←wᵢⱼ+ηΔwᵢⱼ, where wᵢⱼ is the weight value for the i^{th} row and j^{th} column of the cross-point array 104.

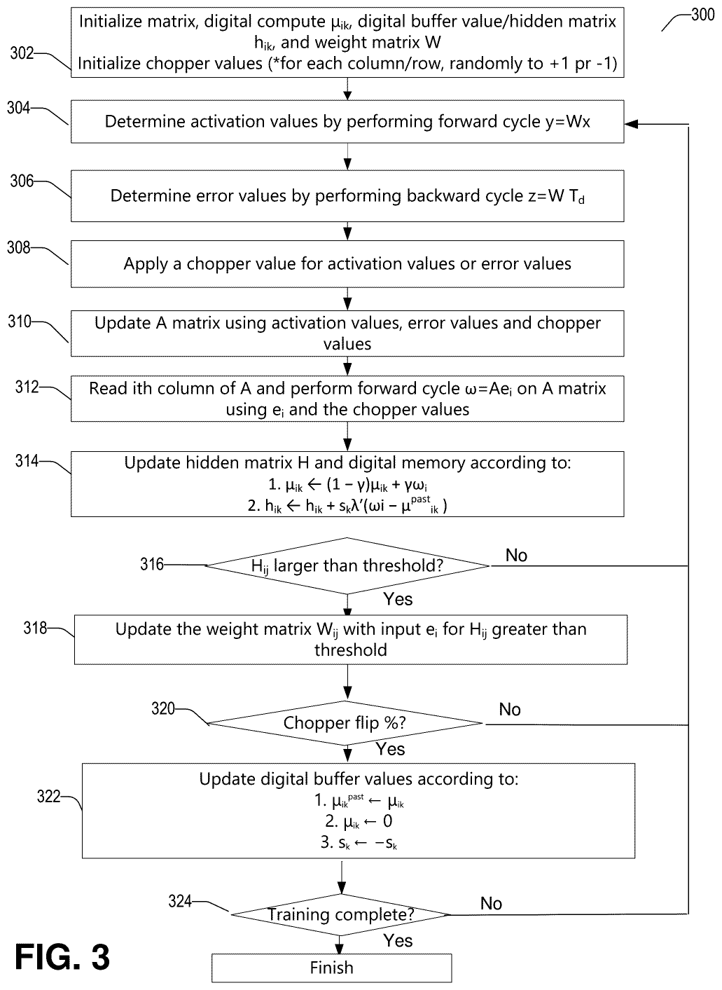

FIG. 3 is a diagram illustrating an example method 300 for training a DNN according to an embodiment. During training, the weight updates are accumulated first on an A matrix. The A matrix is a hardware component made up of rows and columns of RPUs that have symmetric behavior around the zero point. The weight updates from the A matrix are then selectively moved to a weight matrix W. The weight matrix W is also a hardware component made up of rows and columns of RPUs. The training process iteratively determines a set of parameters (weights wᵢⱼ) that maximizes the accuracy of the DNN. The matrix W is initialized to randomly distributed values using the common practices applied for DNN training. The hidden matrix H, stored digitally, is initialized to zero.

During training, the weight updates are performed on the A matrix. Then, the information processed by A matrix is accumulated in the hidden matrix H (a separate matrix effectively performing a low pass filter). The values of the hidden matrix H that reach an update threshold are then applied to the weight matrix W. The update threshold effectively minimizes noise produced within the hardware of the A matrix. For elements of the A matrix that are initialized with a bias, however, the update threshold will be reached prematurely since each iteration from the element carries a consistent update (either positive or negative) that is based on the bias, and not based on the weight updates associated with training the DNN. The chopper value negates the bias by flipping the sign of the bias for certain periods of time, during which time the bias is summed to the hidden matrix H with the opposite sign. Specifically, some period of time will sum the weight value plus a positive bias to the hidden matrix H while other time periods sum the weight value plus a negative bias to the hidden matrix H. A random flipping of the chopper value means that the time periods with positive bias tend to even out with the time periods with negative bias. Therefore, the hardware bias and noise associated with non-ideal RPUs are tolerated (or absorbed by H matrix), and hence give fewer test errors compared to the standard SGD technique, a hidden matrix H alone, or other training techniques using asymmetric devices, even with a fewer number of states.

The method 300 initializes the A matrix, the digital compute value p, the hidden matrix H (also stored in a digital buffer), and the weight matrix W in block 302. Initializing the A matrix includes, for example, setting all of the values to zero. The array A can be embodied in one interconnected array.

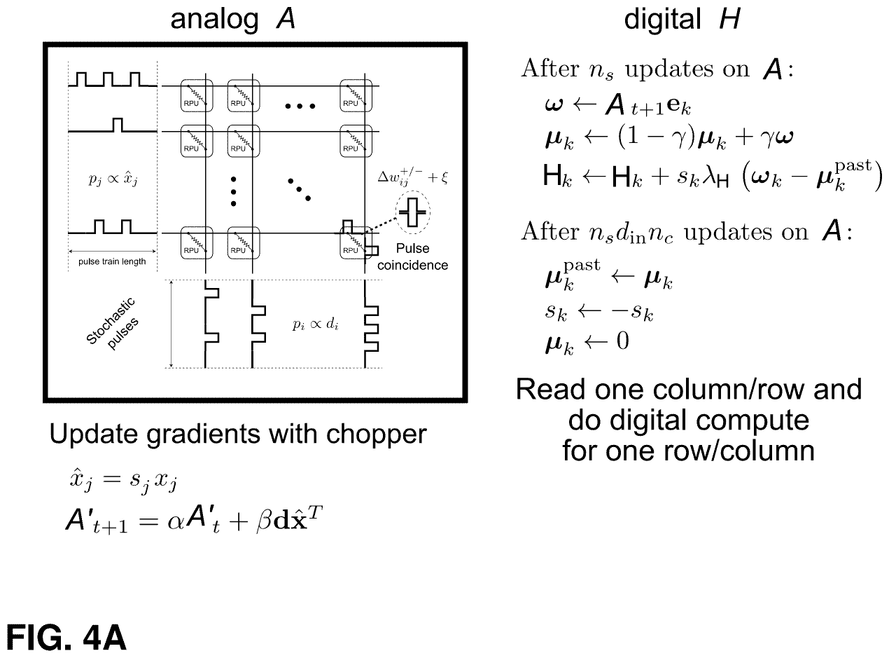

FIGS. 4A-4B are diagrams illustrating interconnected arrays with a digital memory used for estimating reference values on the fly. As illustrated, μ represents the recent past of the gradient update matrix A. In some embodiments, the recent past μ, may be used in a difference calculation in digital storage or memory resulting in a value ω that is used to update H. This creates a floating-point representation of the reference value. The reference value, in this case changes over time according to method 300. This dynamic updating and on the fly calculation of the reference value helps eliminate bias in previous systems using a hardware reference RPU matrix for the reference value.

Initialization of the hidden matrix H includes zeroing the current values stored in the matrix or allocating digital storage space on a connected computing device. Initialization of the weight matrix W includes loading the weight matrix W with random values so that the training process for the weight matrix W may begin. ω is assigned based on a read from the A matrix of each column or row, where ω is the digitally converted values processed after using the ADC.

The digital H is a hidden matrix used to filter the gradient values computed onto A. The ω is a read of the analog A matrix, which may be read each column or row, by putting a unit vector (e.g. [1 0 0 0]) with voltages in. The weights of that column in current units will be retrieved, which is changed back to digital by using an ADC. X is the scaling factor, or the learning rate. S is used for the changing chopper value which switches between negative and positive.

Once a threshold is met on H, a pulse is then sent to the weight matrix, W. In other words, the gradient is placed onto the A crossbar RPU. As placed the gradient includes a lot of noise. The gradient is read again, applying a chopper and subtracting the reference values to remove any bias, and then added onto a filter matrix, filtering the noise out. The gradient is then integrated over time, and once the gradient reaches a threshold, the weight is updated. So, therefore, the weight W is only seldomly modified, without any bias applied. This drastically improves the noise properties and accuracy of prior art RPU algorithms.

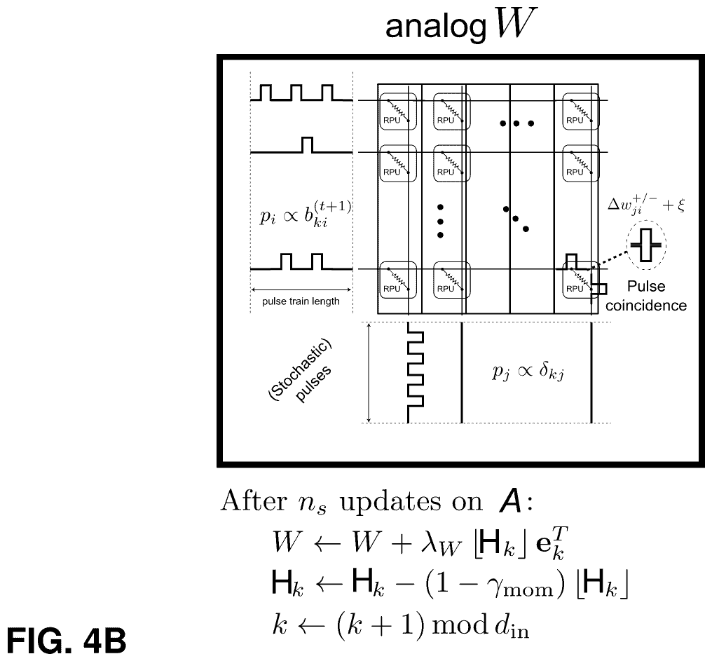

The method 300 includes determining activation values by performing a forward cycle using the weight matrix W (block 304). FIG. 5 is a diagram illustrating a forward cycle being performed according to an embodiment. The forward cycle involves computing a vector-matrix multiplication (y=Wx) where the activation values embodied as an input vector x represents the activities of the input neurons, and the weight matrix W stores the weight values between each pair of the input and output neurons. FIG. 5 shows that the vector-matrix multiplication operations of the forward cycle are implemented in a cross-point array 502 of RPU devices, where the stored conductance values in the cross-point array 502 forms the matrix.

The input vector x is transmitted as voltage pulses through each of the conductive column wires 512, and the resulting output vector y is read as the current output from the conductive row wires 510 of cross-point array 502. An analog-to-digital converter (ADC) 513 is employed to convert the analog output vectors 516 from the cross-point array 502 to digital signals.

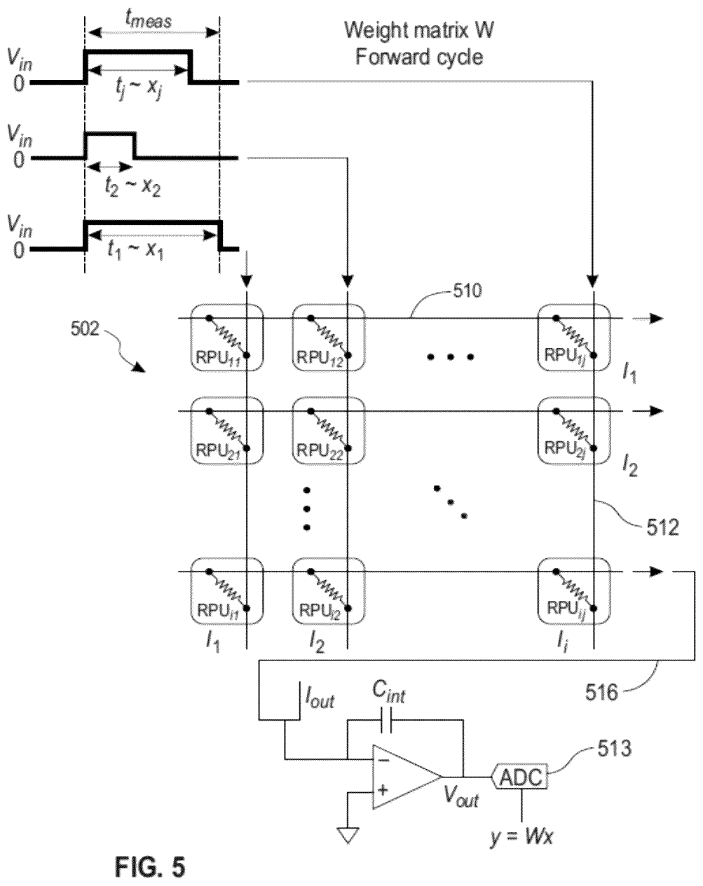

The method 300 also includes determining error values by performing a backward cycle on the weight matrix W (block 306). FIG. 6 is a diagram illustrating a backward cycle being performed according to an embodiment. Generally, the backward cycle involves calculating the error value δ and backpropagating that error value δ through the weight matrix W via a vector-matrix multiplication on the transpose of the weight matrix W (i.e., z=W^{T}δ, where W^{T} indicates the transpose of the matrix W), where the vector δ represents the error calculated by the output neurons and the vector z is further processed using the derivative of neuron non-linearity and then passed down to the previous layers.

FIG. 6 illustrates that the vector-matrix multiplication operations of the backward cycle are implemented in the cross-point array 502. The error value δ is transmitted as voltage pulses through each of the conductive row wires 510, and the resulting output vector z is read as the current output from the conductive column wires 512 of the cross-point array 502. When voltage pulses are supplied from the row wires 510 as input to the backward cycle, then a vector-matrix product is computed on the transpose of the weight matrix W. As also shown in FIG. 6, the ADC 513 is employed to convert the (analog) output vectors 518 from the cross-point array 502 to digital signals.

The method 300 also includes applying a chopper value to the activation values or the error values (block 308). The chopper values may be applied by a chopper (e.g., chopper 116 from FIG. 1), which is included for each row wire and each column wire in the A matrix 502. In certain embodiments, the cross point array 502 may have choppers only on the column wires 506, or only on the row wires 504. After the chopper values are applied to the activation values or the error values, the method 300 also includes updating the A matrix with the activation values, error values, (input vectors x and δ), and chopper values (block 310).

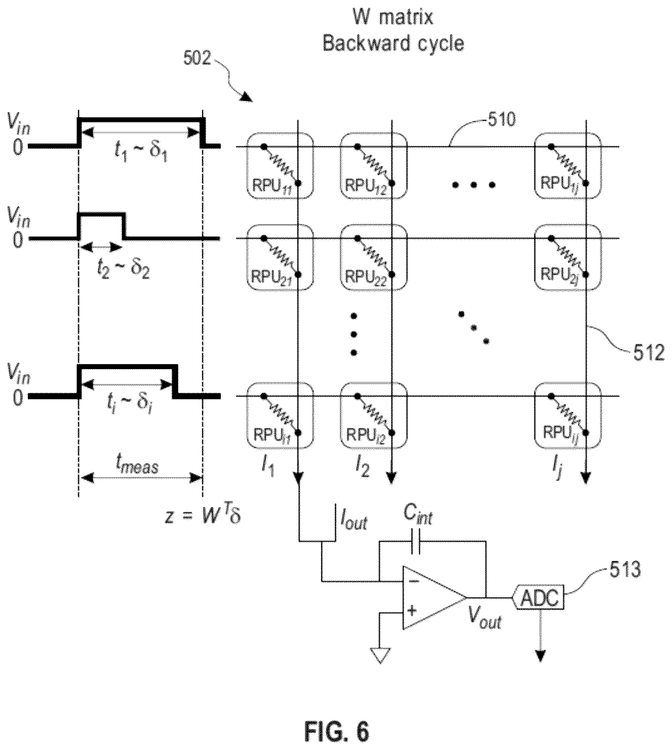

FIG. 7 is a diagram illustrating the array A 502 being updated with x propagated in the forward cycle and δ propagated in the backward cycle according to an embodiment. Each row and column has a chopper value 550 applied to the respective wire. The sign of the chopper value 550 is represented as “+” for positive chopper value (i.e., no change to the activation value or error value) or an “X” for a negative chopper value (i.e., sign change to the activation value or error value). The updates are implemented in cross-point array 502 by transmitting voltage pulses representing vector x (from the forward cycle) and vector δ (from the backward cycle) simultaneously supplied from the conductive column wires 506 and conductive row wires 504, respectively. In this configuration, each RPU in cross-point array 502 performs a local multiplication and summation operation by processing the voltage pulses coming from the corresponding conductive column wires 506 and conductive row wires 504, thus achieving an incremental weight update. The forward cycle (block 304) the backward cycle (block 306) and updating the A matrix with the input vectors from the forward cycle and the backward cycle (block 310) may be repeated a number of times to improve the updated values of the A matrix.

The method 300 also includes reading an i^{th} column of A by performing a forward cycle on the A matrix using an input vector eᵢ, (i.e., y′=Aeᵢ) and the chopper values (block 312). At each time step a new input vector eᵢ is used and the sub index i denotes that time index. As will be described in detail below, according to an example embodiment, input vector eᵢ is a one hot encoded vector. For instance, as is known in the art, a one hot encoded vector is a group of bits having only those combinations having a single high (1) bit and all other bits a low (0). To use a simple, non-limiting example for illustrative purposes, assume a matrix of the size 4×4, the one hot encoded vectors will be one of the following vectors: [1 0 0 0], [0 1 0 0], [0 0 1 0] and [0 0 0 1]. At each time step a new one hot encoded vector is used and the sub index i denotes that time index. It is notable, however, that other methods are also contemplated herein for choosing input vector eᵢ.

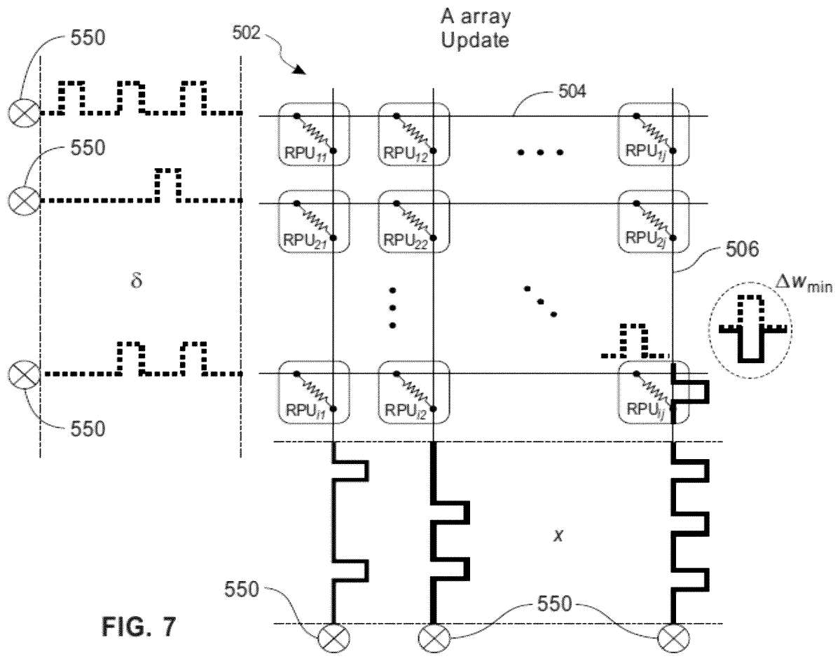

FIG. 8 is a diagram illustrating reading an i^{th} column of A by performing a forward cycle y′=Aeᵢ on the A matrix with chopper values according to an embodiment, where eᵢ is the i-the unit vector. Alternatively, Y′=A^{T}eᵢ (a transposed read), could be performed. The input vector eᵢ is transmitted as voltage pulses through each of the conductive column wires 506, and the resulting output vector y′ is read as the current output from the conductive row wires 504 of cross-point array 502. Each column wire 506 and row wire 504 is read with the same chopper value (i.e., positive or negative) with which the A matrix was updated. For example, the first column wire 506ᵢₗ has a positive chopper value (+) in FIG. 7 and FIG. 8, the second column wire 506ᵢ₂ has a negative chopper value (X) in FIG. 7 and FIG. 8, and the first row wire 504ᵢ₁ has a negative chopper value (X) in FIG. 7 and FIG. 8. When voltage pulses are supplied from the column wires 506 as input to this forward cycle, then a vector-matrix product is computed. The method 300 includes updating a hidden matrix H (block 314).

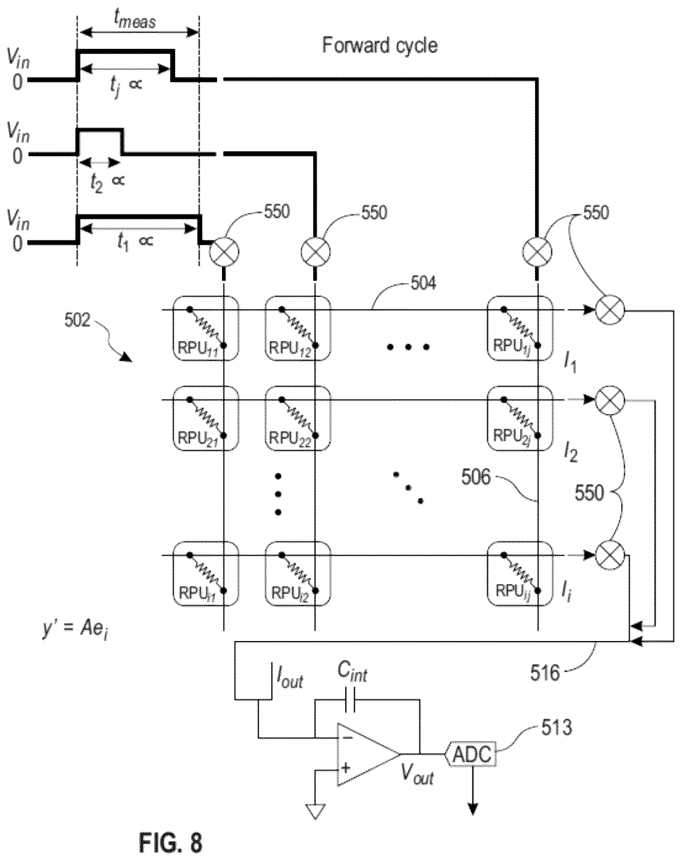

FIG. 9 is a diagram illustrating the hidden matrix H 902 being updated with the values calculated in the forward cycle of the A matrix 904. The hidden matrix H 902 is a digital matrix rather than a physical device like the A matrix and the weight matrix W, that stores an H value 906 (i.e., Hᵢⱼ) for each RPU in the A matrix (i.e., each RPU located at Aᵢⱼ). As the forward cycle is performed, an output vector y′eᵢ^{T} is produced, alternatively called ω. This output vector is used to compute the other digital matrices as detailed below, and is also used to update the hidden matrix H. Thus, each time the output vector is read, the hidden matrix H 902 changes. For those RPUs with low noise levels, the H value 906 will grow consistently. For constant gradients and inputs, the growth of the value may be in the positive or negative direction depending on the value of the output vector ω. If the output vector ω includes significant noise, then its values are likely to be positive for one iteration and negative for another. This combination of positive and negative output vector ω values means that the H value 906 will grow more slowly and more inconsistently.

The hidden matrix value may be updated on the fly using the digital storage storing and updating a value of μ as such:

For the digital compute in each transfer cycle do (for each element i of one read-out vector k):

1. μᵢₖ←(1−γ)μᵢₖ+γωᵢ

2. hᵢₖ←hᵢₖ+sₖλ′(ωᵢ−μᵢₖ^{past}),

Where ω is the read-out weight vector, hᵢₖ is the digital buffer value, sₖ the current chopper sign, λ is a learning rate and μ is a floating point reference which changes over time and on various iterations. K may be increased with wrap around every ns updates onto M.

Each time a vector k is read, after the digital compute, the buffer (with threshold) may be written to the weight matrix W. γ is a user-defined parameter and positive or zero and usually set to 2/p where p is the switching frequency, assuming regular switching.

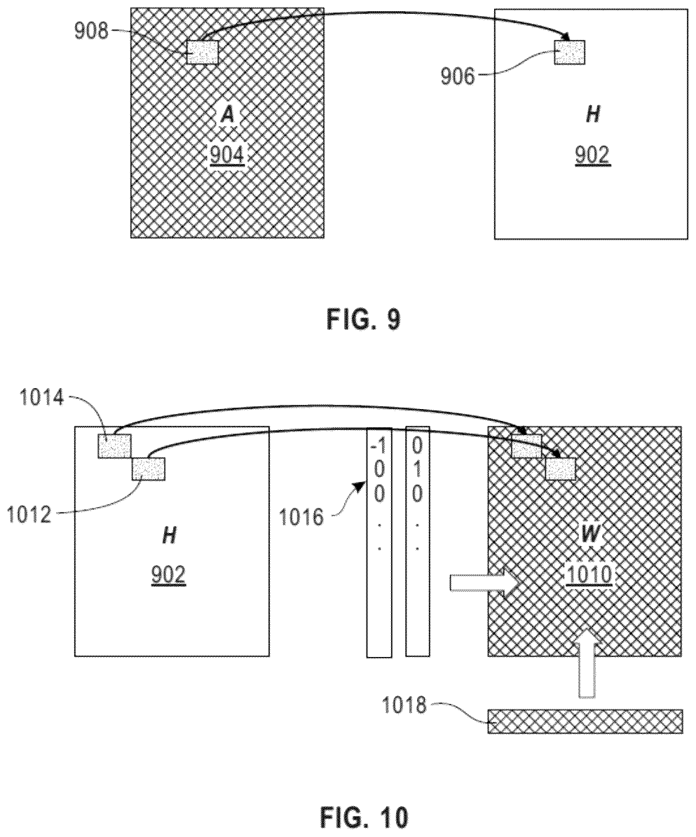

As the H values 906 grow, the method 300 includes tracking whether the H values 906 have grown larger than a threshold (block 316). If the H value 906 at a particular location (i.e., Hᵢⱼ) is not larger than the threshold (block 316 “No”), then the method 300 repeats from performing the forward cycle (block 304) through updating the hidden matrix H (block 314) and potentially flipping the chopper value (block 320-322). If the H value 906 is larger than the threshold (block 316 “Yes”), then the method 300 proceeds to transmitting input vector eᵢ to the weight matrix W, but only for the specific RPU (block 318). As mentioned above, the growth of the H value 906 may be in the positive or negative direction, so the threshold is also a positive or negative value. FIG. 10 is a schematic diagram of the hidden matrix H 902 being selectively applied back to the weight matrix W 1010 according to an embodiment.

FIG. 10 shows a first H value 1012, and a second H value 1014 that have reached over the threshold value and are being transmitted to the weight matrix W 1010. The first H value 1012 reached the positive threshold, and therefore carries a positive one: “1” for its row in the input vector 1016. The second H value 1014 reached the negative threshold, and therefore carries a negative one: “−1” for its row in the input vector 1016. The rest of the rows in the input vector 1016 carry zeroes, since those values (i.e., H values 906) have not grown larger than the threshold value. The threshold value may be much larger than the values being added to the hidden matrix H. For example, the threshold may be ten times or one hundred times the expected strength of the updated values per cycle. Since no bias is added onto the H matrix because of on-the-fly computed reference values, the threshold does typically not need to be overly large. Higher threshold values reduce the frequency of the updates performed on weight matrix W. The filtering function performed by the H matrix, however, decreases the error of the objective function of the neural network. These updates can only be generated after processing many data examples and therefore also increase the confidence level in the updates. This technique enables training of the neural network with noisy RPU devices having only limited number of states even with shifting or unstable symmetry points. After the H value is applied to the weight matrix W, the H value 906 is reset to zero, and the iteration of the method 300 continues.

The method 300 also includes flipping the sign of the chopper value at a flip percentage (block 320). The chopper value, in certain embodiments, is flipped only after the chopper product is added to the hidden matrix H. That is, the chopper value is used twice: once when the activation values and error values are written to the A matrix; and once when the forward cycle is read from the A matrix. The chopper value should not be flipped before the H matrix is updated. The flip percentage may be defined as a user preference such that after each chopper product is added to the hidden matrix H, the chopper has a percentage chance of flipping the chopper value. For example, a user preference may be fifty percent, such that half of the time, the chopper value has a chance of changing the sign (i.e., positive to negative or negative to positive) after the chopper product is calculated. In other embodiments the chopper may be flipped every three or four times through the cycle, for example.

When the chopper is determined to be flipped (Yes, block 320) then the digital buffer values are further updated for on the fly reference estimation. For example, the following updates may occur:

μᵢₖ^{past}←μᵢₖ,μ past is updated with the current μ value for the i^{th} row and k^{th} column.

μaᵢₖ←0, the value of μᵢₖ is reset.

sₖ←−s, the chopper value is flipped.

The memory space usage can be reduced to 2 times, when μₚₐₛₜ^{ik} is set to the last w value during reset (for example, omitting the running mean with γ=1).

After the chopper value is flipped, and the μ^{past} is updated, the method 300 continues by determining whether training is complete. If the training is not complete, for example a certain convergence criterion is not met (block 324 “No”), then the method 300 repeats starting again by performing the forward cycle γ=Wx. For instance, by way of example only, the training can be considered complete when no more improvement to the error signal is seen. When training is completed (block 324 “Yes”), the method 300 ends.

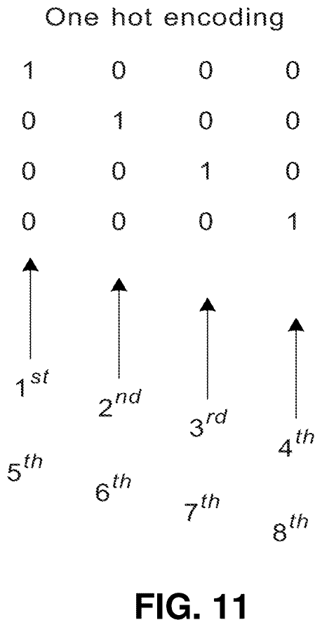

As highlighted above, according to an example embodiment, the input vector eᵢ is a one hot encoded vector which is a group of bits having only those combinations with a single high (1) bit and all other bits a low (0). See, for example, FIG. 11. As shown in FIG. 11, given a matrix of the size 4×4, the one hot encoded vectors will be one of the following vectors: [1 0 0 0], [0 1 0 0], [0 0 1 0] and [0 0 0 1]. At each time step a new one hot encoded vector is used, denoted by the sub index i at that time index.

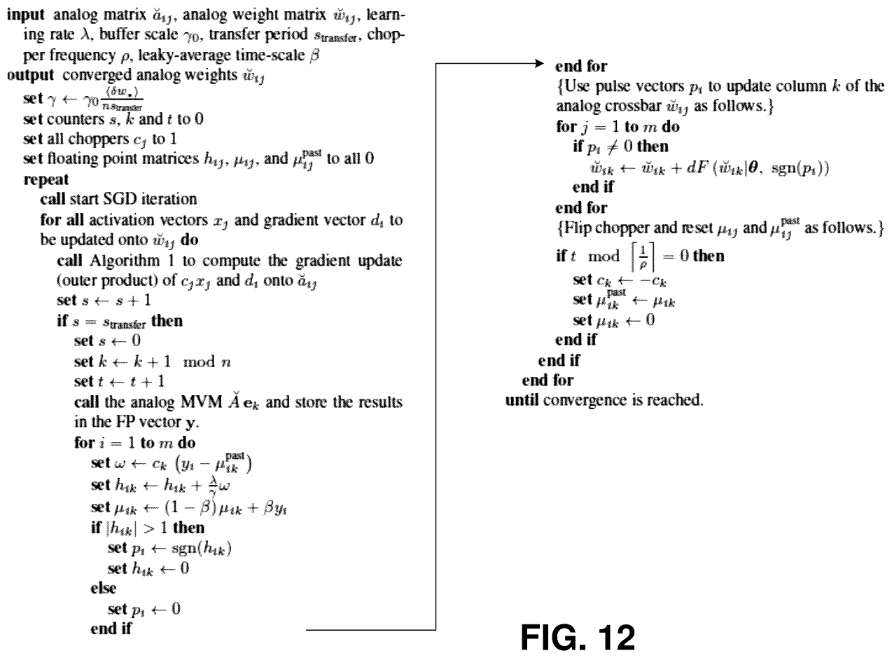

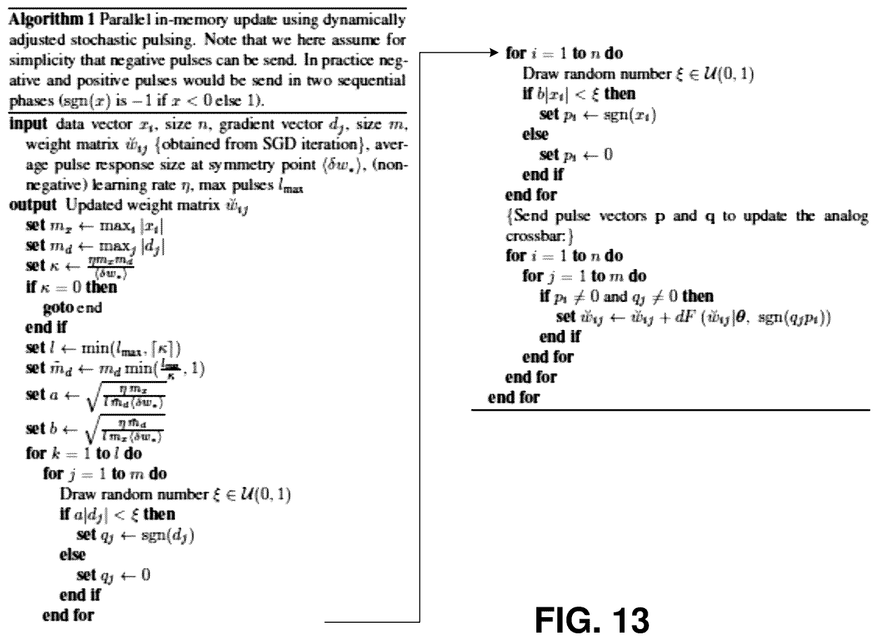

FIG. 12 is a diagram illustrating an example detailed algorithm according to an embodiment of the present disclosure. FIG. 13 is a diagram illustrating an example detailed sub-algorithm according to an embodiment of the present disclosure.

The present invention may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through awire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a particularly configured computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

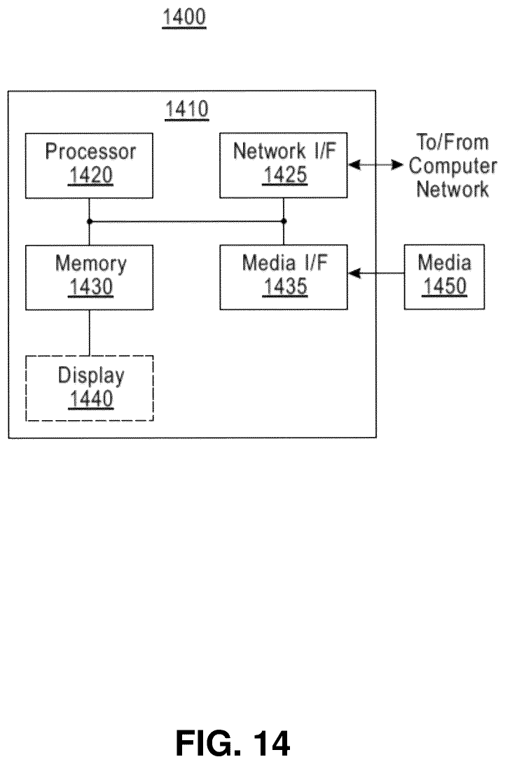

Turning now to FIG. 14, a block diagram is shown of an apparatus 1400 for implementing one or more of the methodologies presented herein. By way of example only, apparatus 1400 can be configured to control the input voltage pulses applied to the arrays and/or process the output signals from the arrays.

Apparatus 1400 includes a computer system 1410 and removable media 1450. Computer system 1410 includes a processor device 1420, a network interface 1425, a memory 1430, a media interface 1435 and an optional display 1440. Network interface 1425 allows computer system 1410 to connect to a network, while media interface 1435 allows computer system 1410 to interact with media, such as a hard drive or removable media 1450.

Processor device 1420 can be configured to implement the methods, steps, and functions disclosed herein. The memory 1430 could be distributed or local and the processor device 1420 could be distributed or singular. The memory 1430 could be implemented as an electrical, magnetic or optical memory, or any combination of these or other types of storage devices. Moreover, the term “memory” should be construed broadly enough to encompass any information able to be read from, or written to, an address in the addressable space accessed by processor device 1420. With this definition, information on a network, accessible through network interface 1425, is still within memory 1430 because the processor device 1420 can retrieve the information from the network. It should be noted that each distributed processor that makes up processor device 1420 generally contains its own addressable memory space. It should also be noted that some or all of computer system 1410 can be incorporated into an application-specific or general-use integrated circuit. Optional display 1440 is any type of display suitable for interacting with a human user of apparatus 1400. Generally, display 1440 is a computer monitor or other similar display.

### CONCLUSION

The descriptions of the various embodiments of the present teachings have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

The components, steps, features, objects, benefits and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

Aspects of the present disclosure are described herein with reference to call flow illustrations and/or block diagrams of a method, apparatus (systems), and computer program products according to embodiments of the present disclosure. It will be understood that each step of the flowchart illustrations and/or block diagrams, and combinations of blocks in the call flow illustrations and/or block diagrams, can be implemented by computer readable program instructions.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the call flow process and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the call flow and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the call flow process and/or block diagram block or blocks.

The flowchart and block diagrams in the Figures illustrate the architecture, functionality, and operation of possible implementations of systems, methods, and computer program products according to various embodiments of the present disclosure. In this regard, each block in the call flow process or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or call flow illustration, and combinations of blocks in the block diagrams and/or call flow illustration, can be implemented by special purpose hardware-based systems that perform the specified functions or acts or carry out combinations of special purpose hardware and computer instructions.

While the foregoing has been described in conjunction with example embodiments, it is understood that the term “example” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A device comprising:
a first matrix comprising a Resistive Processing Unit (RPU) crossbar array with a first set of hidden weights configured for a gradient update for a stochastic gradient descent (SGD) of a deep neural network (DNN);
a second matrix comprising a second set of hidden weights for the DNN stored in a digital medium;
a third matrix comprising a set of reference values, stored in the digital medium, wherein the set of reference values is computed during a transfer cycle of the first set of weights from the first matrix to the second matrix, accounting for a sign-change (a chopper); and
a fourth matrix comprising an RPU crossbar array storing a third set of weights for the DNN that are updated from the second matrix when a threshold is reached for the second set of weights.

2. The device of claim 1, further comprising:
a fifth matrix, stored in the digital medium, configured to compute a next set of reference values from values read from the first matrix, during a chopper cycle and the fifth matrix is configured to partially update the third matrix, after the chopper cycle is completed.

3. The device of claim 1, wherein the second set of weights accounts for a set of previous reference values from a prior iteration of the transfer cycle.

4. The device of claim 1, further comprising:
a fifth matrix used to compute a next set of reference values to be used in a next chopper cycle based on reading from the first matrix, stored in the digital medium.

5. The device of claim 4, wherein the device is configured to assign the set of reference values to the set of previous reference values in the digital medium at a chopper switching time.

6. The device of claim 5, wherein the device is configured to set of reference values to zero at the chopper switching time.

7. The device of claim 6, wherein the device is configured to switch a sign of the chopper at the chopper switching time.

8. The device of claim 1, wherein no RPU crossbar array is configured to store the set of reference values.

9. The device of claim 1, wherein the device is configured to copy a set of previous reference values to a recent read-out weight vector.

10. A computer implemented method comprising:
performing a gradient update for a stochastic gradient descent (SGD) of a deep neural network (DNN) using a first set of hidden weights stored in a first matrix comprising a Resistive Processing Unit (RPU) crossbar array;
storing, in a digital medium, a second matrix comprising a second set of hidden weights for the DNN;
computing a third matrix comprising a set of reference values, upon a transfer cycle of the first set of hidden weights from the first matrix to the second matrix, accounting for a sign-change (a chopper);
storing, in the digital medium, the third matrix; and
updating a third set of weights for the DNN from the second matrix when a threshold is reached for the second set of weights, in a fourth matrix comprising a RPU crossbar array.

11. The method of claim 10, further comprising:
computing a next set of reference values from values read from the first matrix, during a chopper cycle; and
storing a next set of reference values in a fifth matrix, in the digital medium, wherein the fifth matrix is configured to partially update the third matrix, after the chopper cycle is completed.

12. The method of claim 10, wherein the second set of weights accounts for a set of previous reference values from a prior iteration of the transfer cycle.

13. The method of claim 10, further comprising:
computing for the SGD a fifth matrix comprising a set of previous reference values; and
storing the fifth matrix in the digital medium.

14. The method of claim 13, further comprising:
assigning the set of reference values to the set of previous reference values in the digital medium at a switching time of the chopper.

15. The method of claim 14, further comprising:
resetting the set of reference values to zero at the chopper switching time.

16. The method of claim 15, further comprising:
switching a sign of the chopper at the switching time of the.

17. The method of claim 11, wherein no RPU crossbar array is configured to store the set of reference values.

18. The method of claim 11, further comprising:
copying a set of previous reference values to a recent read-out weight vector.

19. A non-transitory computer readable storage medium tangibly embodying a computer readable program code having computer readable instructions to solve a machine learning task, that, when executed, the instructions cause a computer device to carry out a method comprising:
performing a gradient update for a stochastic gradient descent (SGD) of a deep neural network (DNN) using a first set of hidden weights stored in a first matrix comprising a Resistive Processing Unit (RPU) crossbar array;
storing, in a digital medium, a second matrix comprising a second set of hidden weights;
computing a third matrix comprising a set of reference values, during a transfer cycle of the first set of weights from the first matrix to the second matrix, accounting for a sign-change (a chopper);
storing, in the digital medium, the third matrix; and
updating a third set of weights for the DNN from the second matrix when a threshold is reached for the second set of weights, in a fourth matrix comprising a RPU crossbar array.

20. The non-transitory computer readable storage medium of claim 19, wherein the second set of weights accounts for a set of previous reference values from a prior iteration of the transfer cycle.
